(19) United States
(12) Patent Application Publication
(10) Pub. No.: US 2024/0037150 A1
(43) Pub. Date: Feb. 1, 2024

(54) SCHEDULING OPTIMIZATION IN SEQUENCE SPACE

(71) Applicant: QUALCOMM Incorporated, San Diego, CA (US)

(72) Inventors: Yang YANG, San Diego, CA (US); Mukul GAGRANI, San Diego, CA (US); Wonseok JEON, San Diego, CA (US); Edward TEAGUE, San Diego, CA (US); Weiliang ZENG, San Diego, CA (US); Piero ZAPPI, La Jolla, CA (US); Corrado RAINONE, Haarlem (NL); Christopher LOTT, San Diego, CA (US)

(21) Appl. No.: 17/878,677

(22) Filed: Aug. 1, 2022

(51) Int. Cl. G06F 16/901; G06N 5/02

(52) U.S. Cl. CPC G06F 16/9024; G06N 5/022

(57) ABSTRACT

A processor-implemented method for generating a schedule for executing operations of a compute graph includes receiving a graph including multiples nodes connected by edges. Each of the multiple nodes represents an operation to be executed. A set of sequences for executing the nodes is determined based on one or more precedence constraints. One or more sequences are selected from the set of sequences based on a memory constraint associated with a device for executing the nodes. A schedule for executing the nodes on the device is generated based on the selected one or more sequences.

### FIELD OF THE DISCLOSURE

Aspects of the present disclosure generally relate to scheduling execution of operations in a computational graph.

### BACKGROUND

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Given the many useful applications of neural networks, there is increasing demand for use on edge devices such as smartphones. However, edge devices have limited computational resources and generalized models may utilize more complex networks and more computation. As such, the memory footprint and high latency for neural networks make their use challenging, particularly for efficient deployment and inference on resource-limited devices.

Conventional approaches for reducing latency and memory consumption may employ heuristic strategies, designed for general input distribution that are not tailored for problem-specific input distributions. Furthermore, the solution space for determining the schedule for executing operations may be prohibitively large, thereby limiting application of many optimization techniques.

### SUMMARY

The present disclosure is set forth in the independent claims, respectively. Some aspects of the disclosure are described in the dependent claims.

In one aspect of the present disclosure, a processor-implemented method includes receiving a graph including multiples nodes connected by edges. Each of the multiple nodes represents an operation to be executed. The processor-implemented method further includes determining a set of sequences for executing the nodes based on one or more precedence constraints. The processor-implemented method still further includes selecting, one or more sequences from the set of sequences based on a memory constraint associated with a device for executing the nodes. The processor-implemented method also includes generating a schedule for executing the nodes on the device based on the selected one or more sequences.

Another aspect of the present disclosure is directed to an apparatus including means for receiving a graph including multiples nodes connected by edges. Each of the multiple nodes representing an operation to be executed. The apparatus further includes means for determining a set of sequences for executing the nodes based on one or more precedence constraints. The apparatus still further includes means for selecting, one or more sequences from the set of sequences based on a memory constraint associated with a device for executing the nodes. The apparatus also includes means for generating a schedule for executing the nodes on the device based on the selected one or more sequences.

In another aspect of the present disclosure, a non-transitory computer-readable medium with non-transitory program code recorded thereon is disclosed. The program code is executed by a processor and includes program code to receive a graph including multiples nodes connected by edges, each of the multiple nodes representing an operation to be executed. The program code further includes program code to determine a set of sequences for executing the nodes based on one or more precedence constraints. The program code still further includes program code to select, one or more sequences from the set of sequences based on a memory constraint associated with a device for executing the nodes. The program code also includes program code to generate a schedule for executing the nodes on the device based on the selected one or more sequences.

Another aspect of the present disclosure is directed to an apparatus having a memory and one or more processors coupled to the memory. The processor(s) is configured to receive a graph including multiples nodes connected by edges, each of the multiple nodes representing an operation to be executed. The processor(s) is further configured to determine a set of sequences for executing the nodes based on one or more precedence constraints. The processor(s) is still further configured to select, one or more sequences from the set of sequences based on a memory constraint associated with a device for executing the nodes. The processor(s) is also configured to generate a schedule for executing the nodes on the device based on the selected one or more sequences.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture 400 that may modularize artificial intelligence (AI) functions.

FIG. 5A is a diagram illustrating an example compute graph, in accordance with aspects of the present disclosure.

FIG. 5B is a diagram illustrating an example schedule, in accordance with aspects of the present disclosure.

FIG. 6 is a diagram illustrating the reduced search space for determining a schedule for executing operations, in accordance with aspects of the present disclosure.

FIGS. 7A and 7B are diagrams illustrating an example compute graph and an example schedule for executing the nodes, in accordance with aspects of the present disclosure.

FIG. 8 is a flow diagram illustrating a processor-implemented method for scheduling execution of operations, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Many problems in operations research involve performing a sequence of tasks, while both obeying a set of precedence constraints between them and optimizing a cost metric of interest. For example, the sequence of tasks may include a set of operations in a computer program. In this example, an operation may involve or be dependent on outputs from previous operations. As such, the prior operations may serve as precedence constraints for the dependent operation. In another example, the tasks may involve visiting multiple locations in which the order of visits is constrained (e.g., pick-up a package and then deliver the package), while also minimizing the distance traveled. Conventional approaches typically treat such problems via heuristic strategies that are handcrafted or custom for each instance, which is time consuming and requires domain knowledge.

To address these and other challenges, aspects of the present disclosure are directed to generating a schedule for executing the operations by reducing the search space to the sequence space. In accordance with aspects of the present disclosure, the sequence space may be determined based on a set of dependencies between the operations. A memory constraint associated with one or more devices for executing the operations may also be applied to select a subset of the sequences. In turn, the schedule may be generated based on the selected sequences. Accordingly, aspects of the present disclosure may beneficially avoid loss in optimality and may generate schedules for performing tasks (e.g., executing operations) in a manner that reduces latency and power consumption.

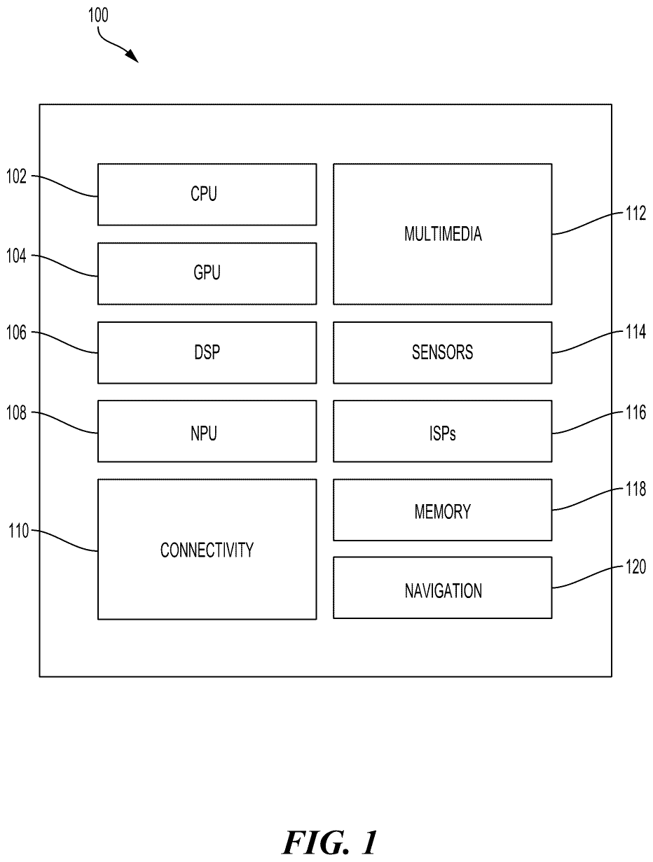

FIG. 1 illustrates an example implementation of a system-on-a-chip (SOC) 100, which may include a central processing unit (CPU) 102 or a multi-core CPU configured for scheduling execution of operations of a compute graph. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive a graph including multiples nodes connected by edges. Each of the multiple nodes represents an operation to be executed. The general-purpose processor 102 may also include code to determine a set of sequences for executing the nodes based on one or more precedence constraints. Additionally, the general-purpose processor 102 may include code to select one or more sequences from the set of sequences based on a memory constraint associated with a device for executing the nodes. The general-purpose processor 102 may further include code to generate a schedule for executing the nodes on the device based on the selected one or more sequences.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

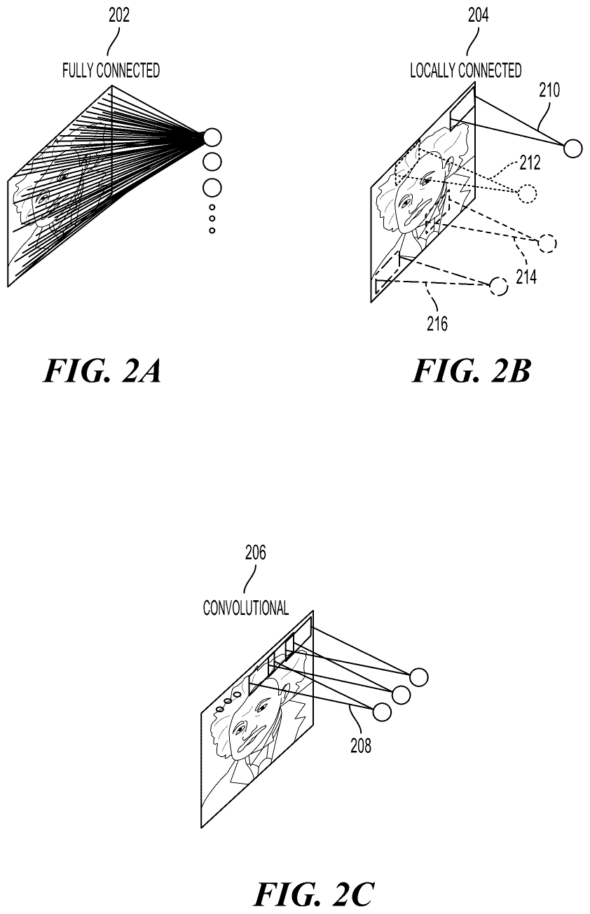

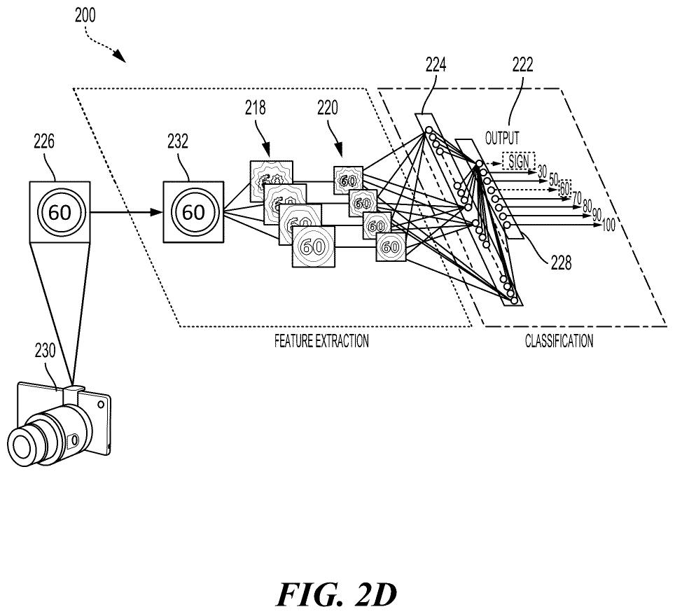

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

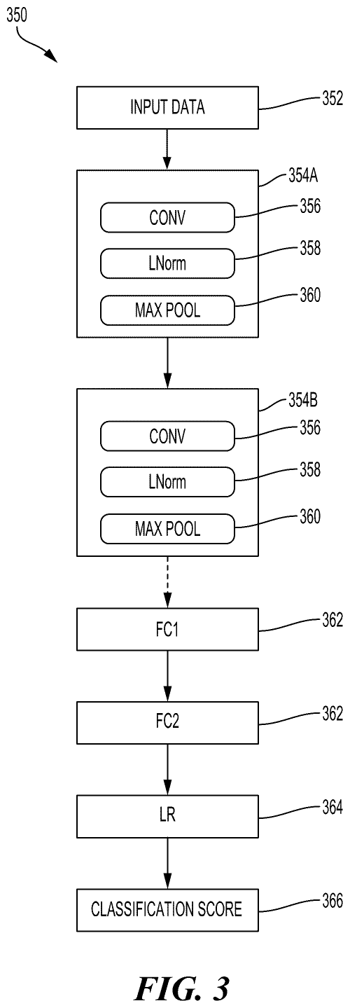

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

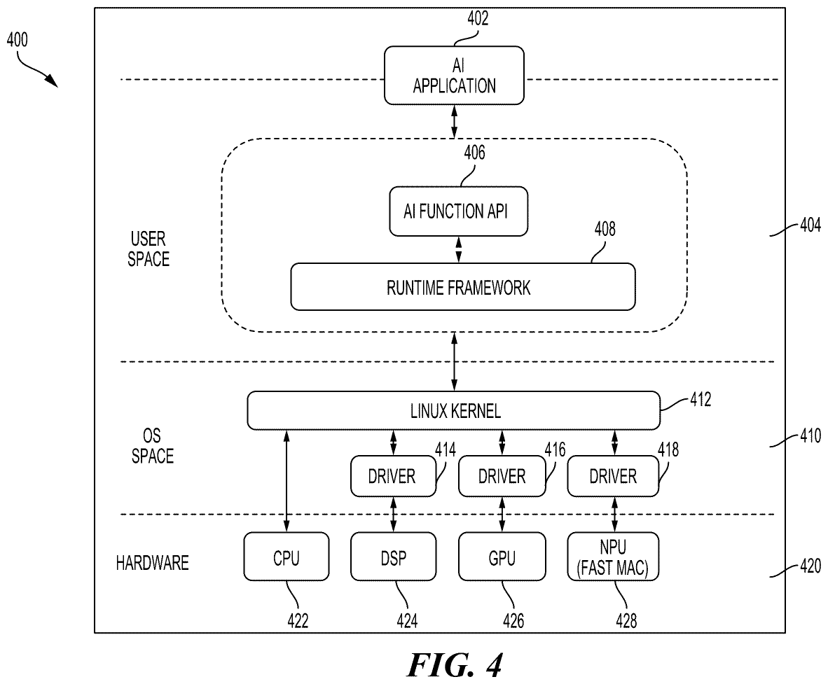

FIG. 4 is a block diagram illustrating an exemplary software architecture 400 that may modularize artificial intelligence (AI) functions. Using the architecture, applications may be designed that may cause various processing blocks of a system-on-a-chip (SOC) 420 (for example a CPU 422, a DSP 424, a GPU 426 and/or an NPU 428) to support adaptive rounding as disclosed for post-training quantization for an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space, such as a Linux Kernel 412, running on the SOC 420. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in a user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the differential neural network may be configured to run on a combination of processing blocks, such as a CPU 422 and a GPU 426, or may be run on an NPU 428.

As described, aspects of the present disclosure are directed to scheduling computation of operations in a sequence space. In accordance with aspects of the present disclosure, precedence constraints for a sequence of operations or tasks may be represented via a graph, such as a directed acyclic graph, for example. A directed graph is a tuple G=(V,E), where V is the set of vertices or nodes and E⊆V×V is the set of edges between the vertices. A tuple is a finite ordered list or sequence of elements. A cycle is a sequence of edges i→ . . . →i with at least one directed edge. Thus, a directed acyclic graph (DAG) is a finite directed graph with no direct cycles. Each of the nodes may represent a task or operation to be performed and the edges may indicate an order for performing the represented tasks.

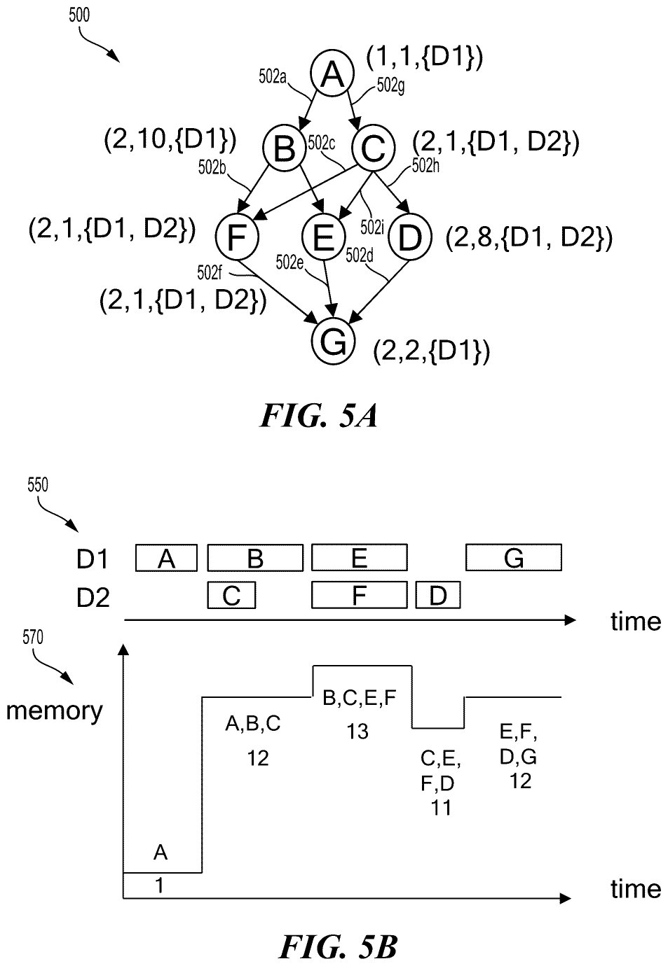

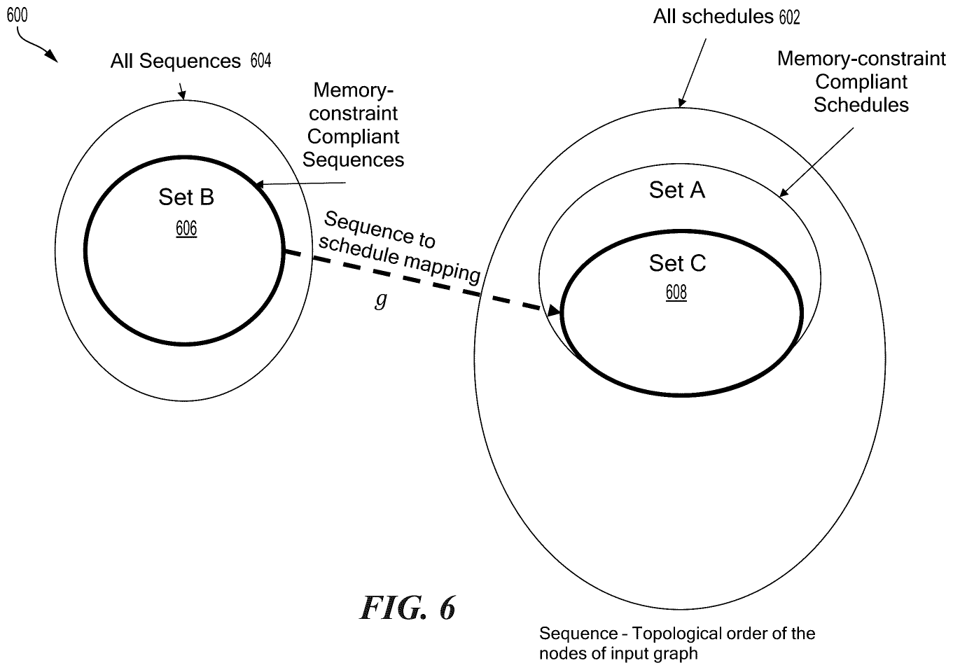

FIG. 5A is a diagram illustrating an example compute graph 500, in accordance with aspects of the present disclosure. Referring to FIG. 5A, the compute graph 500 may be a directed graph, for example. The compute graph 500 may include multiple nodes shown as A, B, C, D, E, F, and G coupled by edges 502a-i. Each node (e.g., A-G) in the graph may represent an operation. The operations may, for example, include operations to be computed for an artificial neural network such as the DCN 350 (shown in FIG. 3), for instance. In some aspects, a node may have a set of attributes including duration, an output memory size, or a set of target devices (e.g., a graphics processing unit (GPU), a digital signal processor (DSP), a neural processing unit (NPU), or the like) on which the respective operation may be executed. Each of the edges may represent a memory dependency. The memory dependency may be considered a precedence constraint between the connected nodes. For instance, as shown in FIG. 5A, an edge 502a is connected from node A to node B and may indicate a precedence constraint in which node B is to consume the output of node A. Put differently, the output of the operation represented by node B is dependent on the output of the operation represented by node A.

In accordance with aspects of the present disclosure, a compute graph 500 may be received as an input. The compute graph 500 may be processed to generate an output including a schedule for executing the nodes. FIG. 5B is a diagram illustrating an example schedule 550 and corresponding memory consumption 570, in accordance with aspects of the present disclosure. As shown in FIG. 5B, the schedule 550 may indicate an executing device (e.g., D1 or D2) and a start time for each of the operations in compute graph 500, for example. In addition, the output schedule 550 may be configured to satisfy the precedence constraints for each node. For instance, the edge 502a indicates that there is a precedence constraint in which the operation of node A is to be completed prior to executing the operation of node B. As such, the schedule 550 may specify that the node A operation is to be executed prior to the node B operation. Although the node C operation may be performed on device D2, node C may not be executed until the node A operation is completed. As such, the node C operation is included in the schedule 550 for device D2 with a start time that follows the completion of the node A operation. In some aspects, the schedule may also be configured to satisfy a memory constraint. For example, the schedule 550 may be configured such that the memory consumption (shown in the memory consumption graph 570) of the schedule 550 is below a predefined threshold (e.g., the size of a tightly coupled memory (e.g., memory 118 of SOC 100)). In this example, the memory threshold may be set at an output size of 13, for example.

Although, the number of devices for executing the operations of the graph may be finite, the duration is a continuous function. Accordingly, determining a schedule that satisfies the precedence and memory constraints is challenging given the vast search space.

To address these and other challenges, aspects of the present disclosure reduce the solution space by using the sequence space. That is, the search space for a schedule may be reduce to the set of sequences that satisfy the precedence constraints. A sequence may be considered a topological order of the nodes (e.g., A-G) of the compute graph 500.

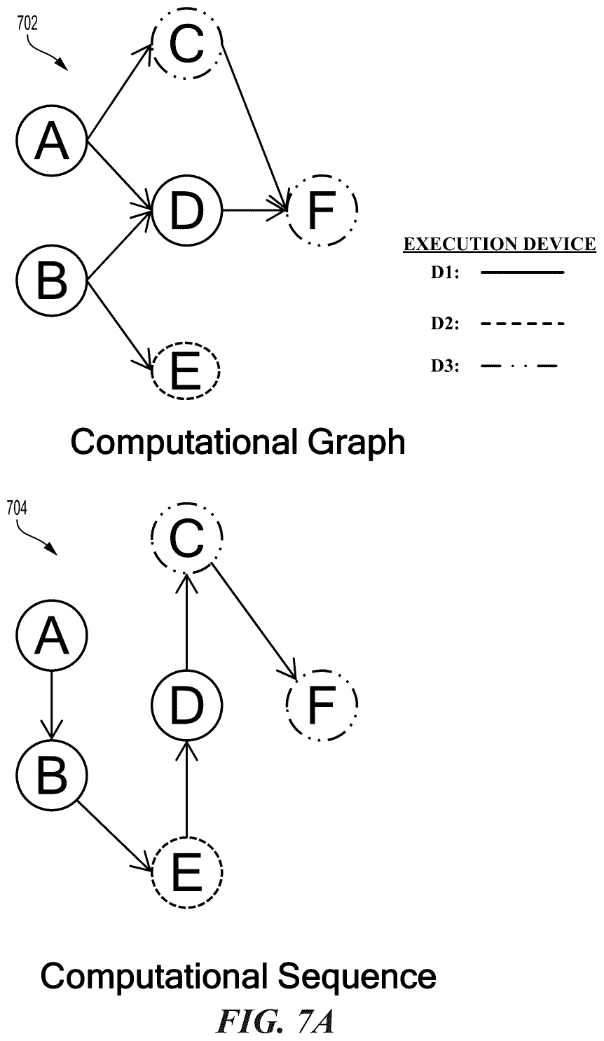

FIG. 6 is a diagram 600 illustrating the reduced search space for determining a schedule for executing operations, in accordance with aspects of the present disclosure. Referring to FIG. 6, rather than searching the solution space of all possible schedules 602 to determine a schedule that satisfies a precedence constraint and a memory constraint, a sequence space 604 including a set of sequences that satisfy the precedence constraint may be searched. The sequence space 604 may then be searched for sequences that satisfy the memory constraint of set B 606. The sequences in set B 606 may then be mapped to the schedule space 602 to determine one or more schedules (e.g., set C 608) that satisfy both the precedence constraint and the memory constraint.

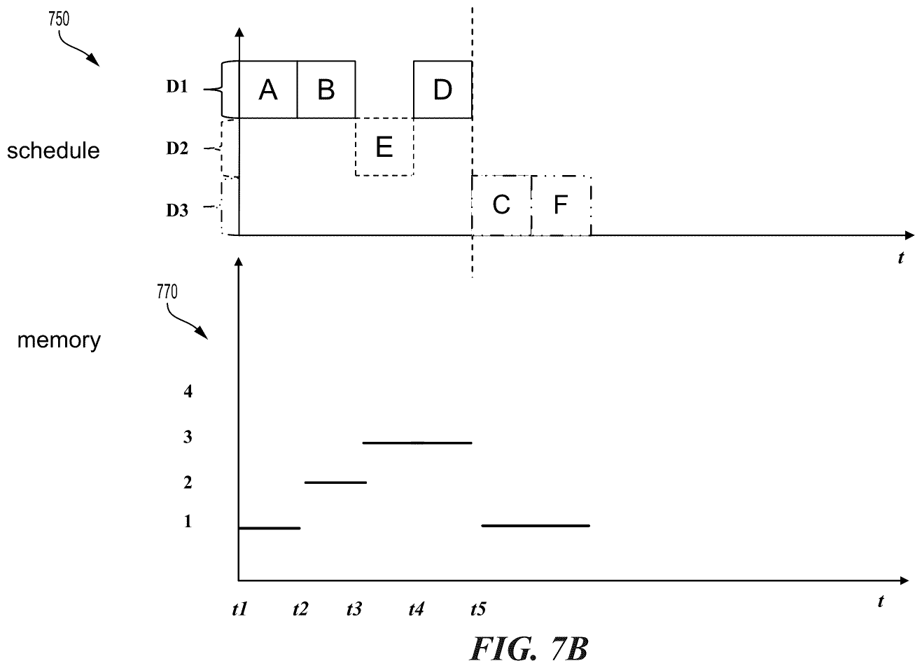

FIGS. 7A and 7B are diagrams illustrating an example compute graph 702 and an example schedule 750 for executing the nodes, in accordance with aspects of the present disclosure. As shown in FIG. 7A, a compute graph 702 may receive an input. The compute graph 702 may include a set of nodes (e.g., A-F) representing operations to be computed. Each of the nodes A-F may include a set of attributes such as a duration, an output memory consumed, and one or more devices on which it may be executed and a duration. For example, nodes A, B, and D may be executed via a device DI, nodes C and F may be executed via a device D2, and node E may be executed via a device D3.

For ease of explanation, in this example, each of the computations may have an output memory size of one and the memory constraint may limit the total output memory size for a tightly coupled memory (e.g., direct memory access device) may be three. Of course, the output memory size and memory constraint are not limiting and the memory sizes and memory constraint may be specified according to design preference, for instance.

In accordance with aspects of the present disclosure, the search space for determining a schedule (e.g., schedule 750) may be reduced to the sequence space. The sequence space may include all sequences which satisfy the precedence constraints indicated in the compute graph 702. For example, a compute sequence 704 may be a sequence in the set of sequences. That is, compute sequence 704 may be one topological ordering of the nodes A-F of the compute graph 702. In this example, the compute sequence 704 may specify execution of the nodes according to A→B→E→D→C→F. In another example, a second computational sequence may specify execution of the nodes according to A→C→B→D→E→F.

Referring to FIG. 7B, the schedule 750 may be determined via a sequence-to-schedule mapping. In some aspects, one or more schedules may be determined using a search algorithm such as a greedy search algorithm, for instance. In the example of FIG. 7B, the schedule 750 may be determined by assigning the nodes to a specified device (e.g., D1, D2, or D3) at a time based on the compute sequence 704 and the memory constraint (memory consumption less than or equal to three). In this example, the order of the sequence may be preserved and nodes may be packed (e.g., executed in concurrently), if permitted by memory. However, this approach is merely exemplary for ease of explanation, and not limiting.

The memory consumption may be given by the sum of the memory output for the node being executed. Additionally, a node may be retained in memory until its immediate child nodes have completed execution. Of course, this approach for memory consumption and computation thereof is merely exemplary and not limiting.

Accordingly, using the compute sequence 704, the first node in the sequence is A. Because, the memory consumption at time t1 is less than 3, node A may begin executing on device D1. Node B may begin processing on device D1 after completion of node A at time t2. However, because the nodes D and C are dependent on the output of node A, the node A output may remain in memory until such nodes are executed. As a result, the memory consumption at time t2 may be 2. The next node in the compute sequence 704 is node E. Although node E may be executed on a different device (e.g., D2), the precedence constraint (shown in 702) indicates that E may start after completion of node B execution. Because the memory constraint is satisfied, node E may begin executing on device D2 at time t3. Node A and node B may also be retained in memory, because node D is dependent on the outputs of node A and node B. Because the memory threshold has been reached, node D may begin executing at time t4 after node E has completed execution. Similarly, although node C may be executed on a different device (e.g., D3) than node D, because the memory threshold (e.g., memory consumption≤3) has been reached, node C may begin executing after node D has completed execution at time t5. Finally, at time t5, node F may begin executing after node C has completed execution.

In some aspects, optimization techniques may be applied such that an improved or, in some aspects, an optimal schedule may be determined. For example, search algorithms such as a tree search (e.g., Monte Carlo tree search algorithm) or a local search algorithm (e.g., 3-Opt local optimization) may minimize the time to completion (e.g., execution of all nodes in the compute graph 702). Moreover, in some aspects, an artificial neural network (e.g., DCN 350 shown in FIG. 3) may be trained end-to-end to determine the schedule. Accordingly, aspects of the present disclosure may beneficially find application in graph-level compiler optimization, for instance. Moreover, aspects of the present disclosure may beneficially improve search efficiency by using sequence space without loss in optimality.

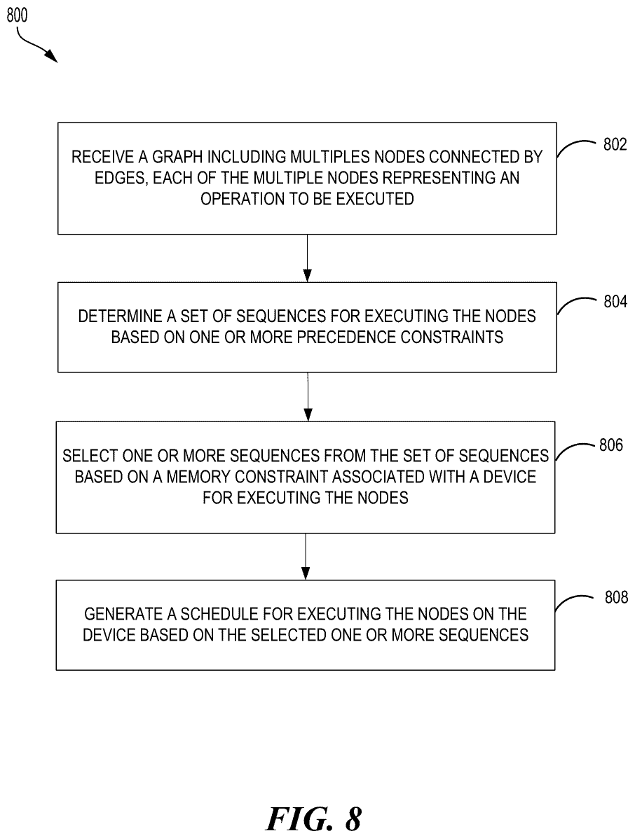

FIG. 8 is a flow diagram illustrating a processor-implemented method 800 for scheduling execution of operations, in accordance with aspects of the present disclosure. As shown in FIG. 8, at block 802, the processor-implemented method 800, receives a graph including multiples nodes connected by edges, each of the multiple nodes representing an operation to be executed. For instance, as described with reference to FIG. 7A, a compute graph 702 may receive an input. In some aspects, the compute graph 702 may be a direct acyclic graph, for example. The compute graph may represent an artificial neural network such as a convolutional neural network (e.g., deep convolutional network 350), a graph neural network (GNN) or other artificial neural networks. The compute graph 702 may include a set of nodes (e.g., A-F) representing operations to be computed. For example, the nodes (e.g., A-F) may represent operations to be processed by a compiler.

At block 804, the processor-implemented method 800 determines a set of sequences for executing the nodes based on one or more precedence constraints. For instance, as described with reference to FIG. 7A, the search space for determining a schedule (e.g., schedule 750) may be reduced from the space of all possible schedules to the sequence space. The sequence space may include all sequences which satisfy the precedence constraints indicated in the compute graph 702. For example, a compute sequence 704 may be a sequence in the set of sequences. That is, compute sequence 704 may be one topological ordering of the nodes A-F of the compute graph 702.

At block 806, the processor-implemented method 800 selects one or more sequences from the set of sequences based on a memory constraint associated with a device for executing the nodes. The memory constraint may indicate a memory threshold. The memory threshold may, for example correspond to a memory size of a memory that is tightly-coupled with the device (e.g., a tightly-coupled memory such as memory 118 of SOC 100 of FIG. 1). In some aspects, the device may comprise one or more of a computer processing unit (CPU), a graphics processing unit (GPU), a digital signal processor (DSP), a neural processing unit (NPU) or a combination thereof, for example.

At block 808, the processor-implemented method 800 generates a schedule for executing the nodes on the device based on the selected one or more sequences. As described, for example, with reference to FIG. 7B, the schedule 750 may be determined via a sequence-to-schedule mapping. In some aspects, one or more schedules may be determined using a search process such as a greedy search process, a tree search process, or a beam search process, for instance. Additionally, the one or more schedules may be generated such that a duration for executing the graph (e.g., compute-to-inference time) may be reduces, and in some aspects optimized (e.g., minimized).

Implementation examples are provided in the following numbered clauses.

1. A processor-implemented method comprising:
receiving a graph including multiples nodes connected by edges, each of the multiple nodes representing an operation to be executed;
determining a set of sequences for executing the nodes based on one or more precedence constraints;
selecting, one or more sequences from the set of sequences based on a memory constraint associated with a device for executing the nodes; and
generating a schedule for executing the nodes on the device based on the selected one or more sequences.

2. The processor-implemented method of clause 1, in which the multiple nodes represent a set of operations to be processed by a compiler.

3. The processor-implemented method of clause 1 or 2, further comprising generating the schedule based on one of a greedy search process, a tree search process, or a beam search process.

4. The processor-implemented method of any of clauses 1-3, in which the generated schedule minimizes a duration for executing the graph.

5. The processor-implemented method of any of clauses 1-4, in which the graph comprises a direct acyclic graph.

6. The processor-implemented method of any of clauses 1-5, in which the graph represents an artificial neural network (ANN).

7. The processor-implemented method of any of clauses 1-6, in which the device comprises one or more of a computer processing unit (CPU), a graphics processing unit (GPU), a digital signal processor (DSP), or a neural processing unit (NPU).

8. An apparatus, comprising:
a memory; and
at least one processor coupled to the memory, the at least one processor configured:
   to receive a graph including multiples nodes connected by edges, each of the multiple nodes representing an operation to be executed;
   to determine a set of sequences for executing the nodes based on one or more precedence constraints;
   to select, one or more sequences from the set of sequences based on a memory constraint associated with a device for executing the nodes; and to generate a schedule for executing the nodes on the device based on the selected one or more sequences.

9. The apparatus of clause 8, in which the multiple nodes represent a set of operations to be processed by a compiler.

10. The apparatus of clause 8 or 9, in which the at least one processor is further configured to generate the schedule based on one of a greedy search process, a tree search process, or a beam search process.

11. The apparatus of any of clauses 8-10, in which the generated schedule minimizes a duration for executing the graph.

12. The apparatus of any of clauses 8-11, in which the graph comprises a direct acyclic graph.

13. The apparatus of any of clauses 8-12, in which the graph represents an artificial neural network (ANN).

14. The apparatus of any of clauses 8-13, in which the device comprises one or more of a computer processing unit (CPU), a graphics processing unit (GPU), a digital signal processor (DSP), or a neural processing unit (NPU).

15. A non-transitory computer-readable medium having program code recorded thereon, the program code executed by a processor and comprising:
program code to receive a graph including multiples nodes connected by edges, each of the multiple nodes representing an operation to be executed;
program code to determine a set of sequences for executing the nodes based on one or more precedence constraints;
program code to select, one or more sequences from the set of sequences based on a memory constraint associated with a device for executing the nodes; and
program code to generate a schedule for executing the nodes on the device based on the selected one or more sequences.

16. The non-transitory computer-readable medium of clause 15, in which the multiple nodes represent a set of operations to be processed by a compiler.

17. The non-transitory computer-readable medium of clause 15 or 16, in which the program code further comprises program code to generate the schedule based on one of a greedy search process, a tree search process, or a beam search process.

18. The non-transitory computer-readable medium of any of clauses 15-17, in which the program code further comprises program code to generate the schedule in which a duration for executing the graph is minimized.

19. The non-transitory computer-readable medium of any of clauses 15-18, in which the graph comprises a direct acyclic graph.

20. The non-transitory computer-readable medium of any of clauses 15-19, in which the graph represents an artificial neural network (ANN).

21. The non-transitory computer-readable medium of any of clauses 15-20, in which the device comprises one or more of a computer processing unit (CPU), a graphics processing unit (GPU), a digital signal processor (DSP), or a neural processing unit (NPU).

22. An apparatus, comprising:
means for receiving a graph including multiples nodes connected by edges, each of the multiple nodes representing an operation to be executed;
means for determining a set of sequences for executing the nodes based on one or more precedence constraints;
means for selecting, one or more sequences from the set of sequences based on a memory constraint associated with a device for executing the nodes; and
means for generating a schedule for executing the nodes on the device based on the selected one or more sequences.

23. The apparatus of clause 22, in which the multiple nodes represent a set of operations to be processed by a compiler.

24. The apparatus of clause 22 or 23, further comprising means for generating the schedule based on one of a greedy search process, a tree search process, or a beam search process.

25. The apparatus of any of clauses 22-24, further comprising means for generating the schedule such that a duration for executing the graph is minimized.

26. The apparatus of any of clauses 22-25, in which the graph comprises a direct acyclic graph.

27. The apparatus of any of clauses 22-26, in which the graph represents an artificial neural network (ANN).

28. The apparatus of any of clauses 22-27, in which the device comprises one or more of a computer processing unit (CPU), a graphics processing unit (GPU), a digital signal processor (DSP), or a neural processing unit (NPU).

In one aspect, the receiving means, determining means, selecting means, and/or generating means may be the GPU 104, program memory associated with the GPU 104, fully connected layers 362, NPU 428, and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method, comprising:
receiving a graph including multiples nodes connected by edges, each of the multiple nodes representing an operation to be executed;
determining a set of sequences for executing the nodes based on one or more precedence constraints;
selecting, one or more sequences from the set of sequences based on a memory constraint associated with a device for executing the nodes; and
generating a schedule for executing the nodes on the device based on the selected one or more sequences.

2. The processor-implemented method of claim 1, in which the multiple nodes represent a set of operations to be processed by a compiler.

3. The processor-implemented method of claim 1, further comprising generating the schedule based on one of a greedy search process, a tree search process, or a beam search process.

4. The processor-implemented method of claim 1, in which the generated schedule minimizes a duration for executing the graph.

5. The processor-implemented method of claim 1, in which the graph comprises a direct acyclic graph.

6. The processor-implemented method of claim 1, in which the graph represents an artificial neural network (ANN).

7. The processor-implemented method of claim 1, in which the device comprises one or more of a computer processing unit (CPU), a graphics processing unit (GPU), a digital signal processor (DSP), or a neural processing unit (NPU).

8. An apparatus, comprising:
a memory; and
at least one processor coupled to the memory, the at least one processor configured:
to receive a graph including multiples nodes connected by edges, each of the multiple nodes representing an operation to be executed;
to determine a set of sequences for executing the nodes based on one or more precedence constraints;
to select, one or more sequences from the set of sequences based on a memory constraint associated with a device for executing the nodes; and
to generate a schedule for executing the nodes on the device based on the selected one or more sequences.

9. The apparatus of claim 8, in which the multiple nodes represent a set of operations to be processed by a compiler.

10. The apparatus of claim 8, in which the at least one processor is further configured to generate the schedule based on one of a greedy search process, a tree search process, or a beam search process.

11. The apparatus of claim 8, in which the generated schedule minimizes a duration for executing the graph.

12. The apparatus of claim 8, in which the graph comprises a direct acyclic graph.

13. The apparatus of claim 8, in which the graph represents an artificial neural network (ANN).

14. The apparatus of claim 8, in which the device comprises one or more of a computer processing unit (CPU), a graphics processing unit (GPU), a digital signal processor (DSP), or a neural processing unit (NPU).

15. A non-transitory computer-readable medium having program code recorded thereon, the program code executed by a processor and comprising:
program code to receive a graph including multiples nodes connected by edges, each of the multiple nodes representing an operation to be executed;
program code to determine a set of sequences for executing the nodes based on one or more precedence constraints;
program code to select, one or more sequences from the set of sequences based on a memory constraint associated with a device for executing the nodes; and
program code to generate a schedule for executing the nodes on the device based on the selected one or more sequences.

16. The non-transitory computer-readable medium of claim 15, in which the multiple nodes represent a set of operations to be processed by a compiler.

17. The non-transitory computer-readable medium of claim 15, in which the program code further comprises program code to generate the schedule based on one of a greedy search process, a tree search process, or a beam search process.

18. The non-transitory computer-readable medium of claim 15, in which the program code further comprises program code to generate the schedule in which a duration for executing the graph is minimized.

19. The non-transitory computer-readable medium of claim 15, in which the graph comprises a direct acyclic graph.

20. The non-transitory computer-readable medium of claim 15, in which the graph represents an artificial neural network (ANN).

21. The non-transitory computer-readable medium of claim 15, in which the device comprises one or more of a computer processing unit (CPU), a graphics processing unit (GPU), a digital signal processor (DSP), or a neural processing unit (NPU).

22. An apparatus, comprising:
means for receiving a graph including multiples nodes connected by edges, each of the multiple nodes representing an operation to be executed;
means for determining a set of sequences for executing the nodes based on one or more precedence constraints;
means for selecting, one or more sequences from the set of sequences based on a memory constraint associated with a device for executing the nodes; and
means for generating a schedule for executing the nodes on the device based on the selected one or more sequences.

23. The apparatus of claim 22, in which the multiple nodes represent a set of operations to be processed by a compiler.

24. The apparatus of claim 22, further comprising means for generating the schedule based on one of a greedy search process, a tree search process, or a beam search process.

25. The apparatus of claim 22, further comprising means for generating the schedule such that a duration for executing the graph is minimized.

26. The apparatus of claim 22, in which the graph comprises a direct acyclic graph.

27. The apparatus of claim 22, in which the graph represents an artificial neural network (ANN).

28. The apparatus of claim 22, in which the device comprises one or more of a computer processing unit (CPU), a graphics processing unit (GPU), a digital signal processor (DSP), or a neural processing unit (NPU).
